(19) United States
(12) Patent Application Publication
(10) Pub. No.: US 2011/0232192 A1
(43) Pub. Date: Sep. 29, 2011

(54) Versatile Door

(76) Inventor: Randall Miller, Mountain Home, ID (US)

(21) Appl. No.: 12/730,231

(22) Filed: Mar. 24, 2010

(51) Int. Cl. E06B 7/00; E06B 3/70; E05C 19/00; E05C 19/08

(52) U.S. Cl. 49/70; 49/503

(57) ABSTRACT

A versatile door has a latch side removeable from the door body. When the latch side is removed, one or more door panels may be removed from the door body. Panels may be removed for refinishing, repair or replacement. Other panel types such as panels with message boards, illumination or openings can customize a door for a variety of purposes.

### CROSS REFERENCE TO RELATED APPLICATIONS

None.

### FEDERALLY SPONSORED RESEARCH OR DEVELOPMENT

Not applicable.

### JOINT RESEARCH AGREEMENT

Not applicable

### SEQUENCE LISTING

Not applicable

### FIELD OF THE INVENTION

The present invention relates to the field of doors for residences, commercial and industrial buildings.

### BACKGROUND OF THE INVENTION

Doors have existed throughout history in most types of structures. In addition to keeping out weather or intruders, doors can also have decorative and other functional aspects.

### SUMMARY OF THE INVENTION

In one embodiment, a versatile has a door body and a removable latch side attached to the door body by a retainer system adapted to removably attach the latch side to the door body. Together, the door body and latch side define an inner area adapted to capture a panel. In other embodiments a second inner area is defined by the door body and latch side and is capable of capturing a second panel. The panels are easily removable, and interchangeable enabling rapid repair, repurposing or redecorating of the door.

Many versions of the retainer system are possible. One retainer system has a foot and receiver on the lower end of the door to attach the latch side to the door body. A hasp and hasp catch secure the upper end of the latch side to the door body. When the latch side is removed from the door body, the panels are accessible and removable. When the latch side is attached to the door body by the retainer system, the panel(s) are captured and held in place in the door. Another retainer system uses a screw and thread system to removably hold the latch side to the door body.

A number of ways are possible to form the inner area which captures the panel(s). In some embodiments a shaped channel is attached to the door body and latch side. Other embodiments employ grooves in the door body and latch side. Still other methods are possible.

Other embodiments of the versatile door are made of the traditional rails and stiles which form a door perimeter. The stiles and rails define an inner space adapted to capture one or more panels. Typically, the latch side stile is removable allowing the replacement of one or more panels. Panels are captured by grooves associated with the stiles and rails. The stile and rails may also have reinforcing panels or gussets to hold them rigidly in a fixed relationship.

The latch side may employ a latch spacer about the latch to act as a trim piece for the panel(s). An area of the panel is relieved to accommodate the latch spacer. The panel peripheral surface is configured to be captured by the door body and latch side, while the panel face has one of many possible treatments.

Panel treatments are many and varied. In a simple form, a panel treatment may be a paint, varnish, mural or other surface treatment. Other forms of panel treatment include raised or simulated stiles and rails, bas relief sculpture, fabric coverings, interlocking tiles, painting canvas or other art. On the practical side, another type of treatment is the message medium treatment. The message medium can be a chalk board, white board, peg board, cork board, poster pad, magnetic surface or similar, turning the door into a message center.

Still another treatment is the play surface. The play surface provides an attachment surface for popular children's construction toys such as Legos™, Duplos™, Tinker Toys™, and Kinex™. Children also benefit from the message medium described earlier or with other treatments such as a felt surface, glow-in-the-dark surfaces or shallow shelving.

Another treatment of door panels involves panels with openings. Depending upon the location of the panel openings, they can be used for things like vents, windows, pet doors, mail or delivery slots.

A further panel treatment is illumination. The illumination can be decorative or utilitarian. For example one type of door illumination may use light emitting diodes (LEDs) for holiday lighting or color schemes. Another lighting version may use lighting to illuminate the interior of closets or rooms upon initial entry. Some lighting may be used in combination with a dressing or make-up mirror panel. The light can be adjustable to simulate various lighting environments.

### BRIEF DESCRIPTION OF DRAWINGS

The summary above, and the following detailed description will be better understood in view of the enclosed drawings which depict details of preferred embodiments. Like reference numbers designate like elements. It should however be noted that the invention is not limited to the precise arrangement shown in the drawings. The features, functions and advantages can be achieved independently in various embodiments of the claimed invention or may be combined in yet other embodiments.

FIG. 1 shows one embodiment of the versatile door with the latch side being removed from the door body.

FIG. 2 shows one embodiment of the versatile door with the latch side attached to the door body.

FIG. 3 shows a cross sectional view of the embodiment of FIG. 2.

FIGS. 4A-4C show the operation of one embodiment of a retainer system on the upper end of a versatile door.

FIGS. 5A-5B show the operation of one embodiment of a retainer system on the lower end of a versatile door.

FIG. 6 shows the operation of one embodiment of a retainer system based on screws.

FIG. 7 shows the addition or removal of panels to or from one embodiment of the versatile door.

FIG. 8 shows a partially exploded view of one embodiment of the versatile door.

FIG. 9 shows one embodiment of the channel or slots in a versatile door.

FIG. 10 shows one embodiment of a panel adapted for use in a versatile door.

FIG. 11 shows one embodiment of a versatile door with openings.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modification to the various disclosed embodiments may be made and other embodiments may be utilized, without departing from the spirit and scope of the present invention. The following detailed description is therefore, not to be taken in a limiting sense.

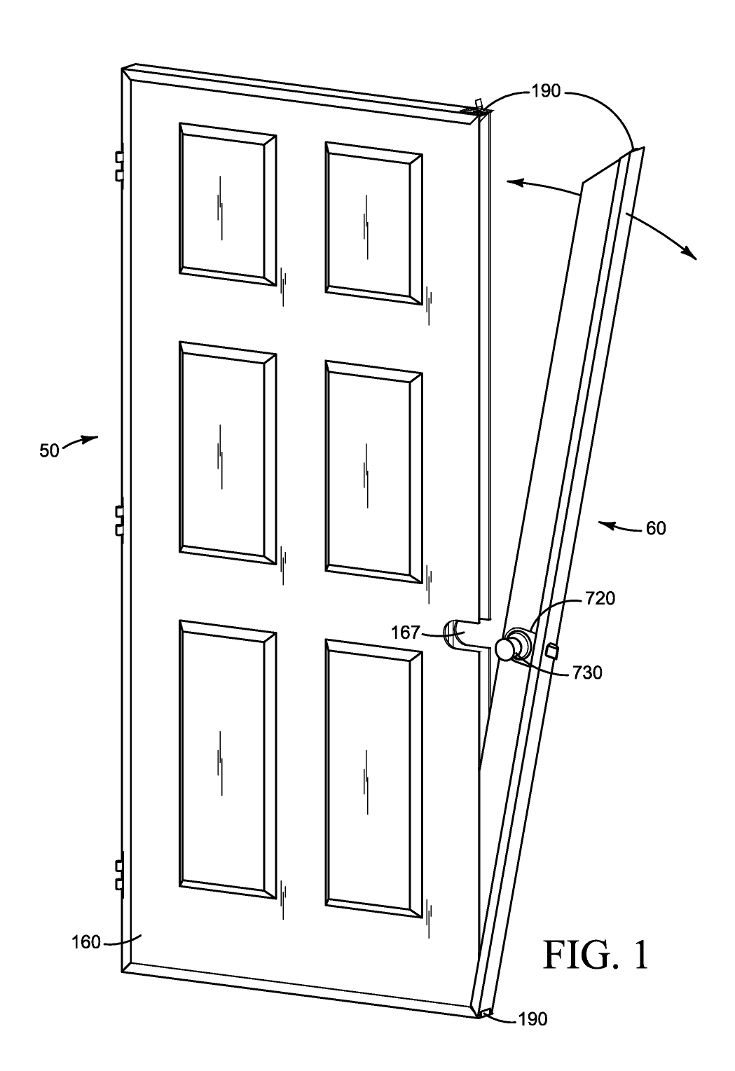

FIG. 1 shows one embodiment of the versatile door. The door has a door body 50 and a latch side 60. The latch side 60 is removably attached to the door body 50 by a retainer system 190. In FIG. 1 the latch side 60 is released from the retainer system 190 at the top of the door body 50 and is able to rotate toward or away from the door body 50. The latch side 60 has a latch 730 and a latch spacer 720. Together the door body 50 and latch side 60 capture a door panel 160. A recess 167 in the door panel 160 accommodates the latch spacer 720.

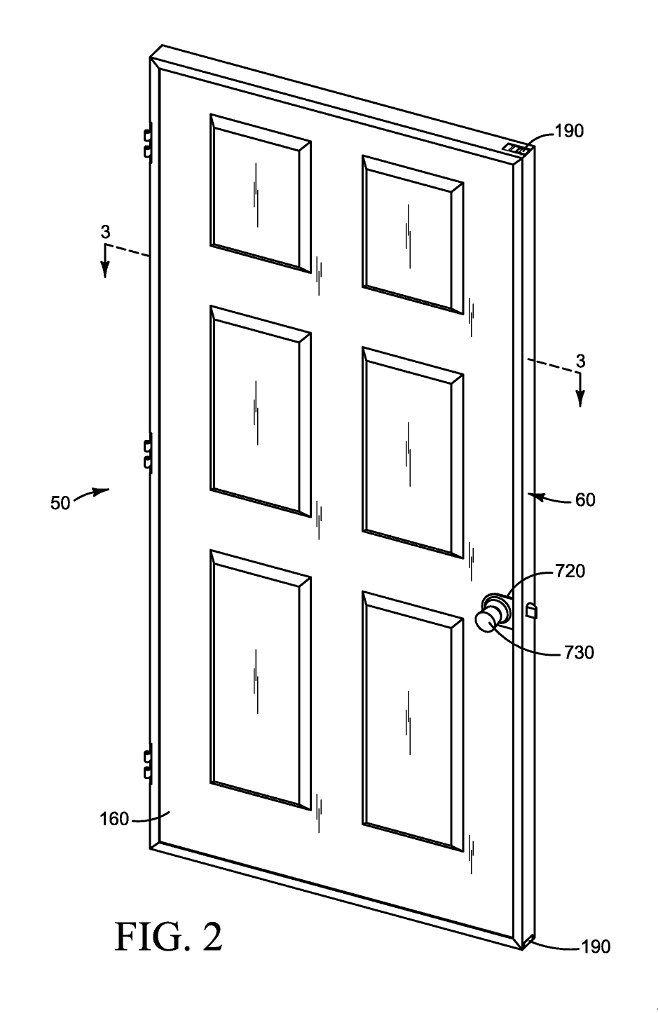

FIG. 2 shows the embodiment of the versatile door of FIG. 1 with the latch side 60 retained and held together in alignment against the door body 50 by the retainer system 190. The latch side 60 is held in place against the door body 50 by the retainer system 190 at both the top and bottom of the versatile door. The door body 50 and latch side 60 define a space (described later) which captures the panel 160. The recess 167 (of FIG. 1) in the door panel 160 fits about the latch spacer 720.

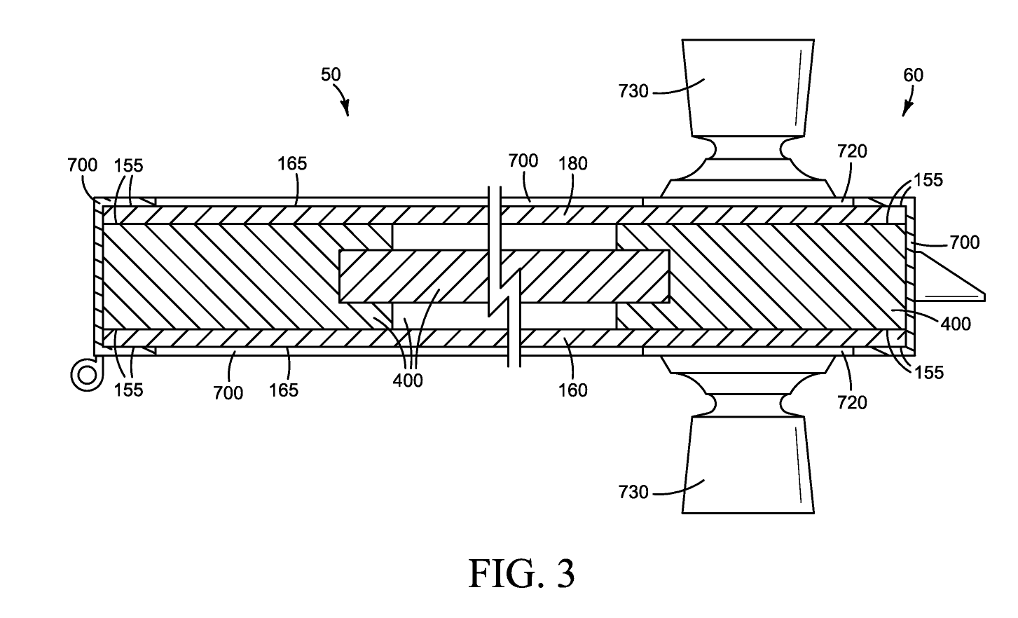

FIG. 3 shows a cross sectional view of the embodiment of FIG. 2. The door body 50 has reinforcements 400 which add strength and rigidity to the versatile door. The latch side 60 also has reinforcements 400 which add strength and rigidity. A shaped channel 700 on both the door body 50 and latch side 60 and together with the door body 50 and latch side 60 define an inner space capable of capturing a panel 160 or 180. Two panels 160 and 180 are shown in FIG. 3, but some embodiments may use only one panel. The panels 160 and 180 have surfaces 155 which are adapted to be captured by the shaped channel 700 and the door body 50 and latch side 60. This surface 155 fits into the space between the shaped channel 700 and the door body 50 or latch side 60. the panels 160, 180 also have a treatment 165 which will be described in detail in conjunction with other figures.

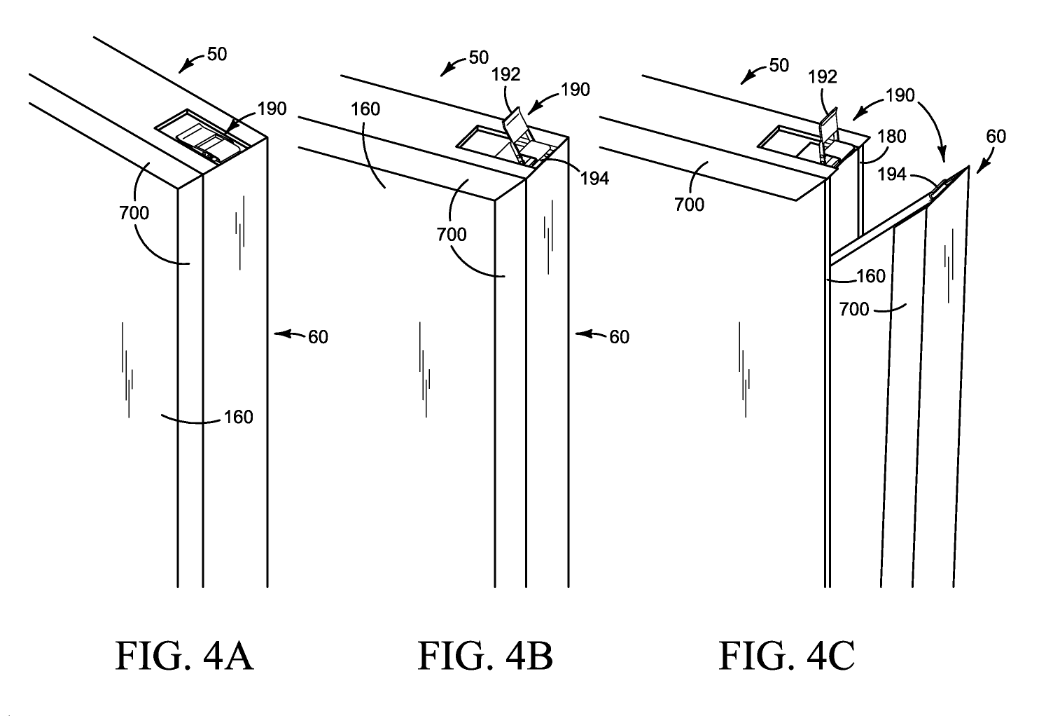

FIGS. 4A-4C shows one embodiment of the retainer system 190 on the upper end of the versatile doors of FIGS. 1 and 2. In FIG. 4A the retainer system 190 is closed holding the latch side 60 tightly against the door body 50. The panel 160 is captured and held or restrained in place between the door body 50 and latch side 60 by the shaped channels 700. In FIG. 4B the hasp 192 of the retainer system 190 is open and releases the hasp catch 194. In FIG. 4C the latch side 60 is pulled away from the door body 50 exposing the edges of the previously captured panels 160 and 180. In FIG. 4C the panels 160 and 180 can be pulled or slid out from the door body 50 in the direction of the latch side 60.

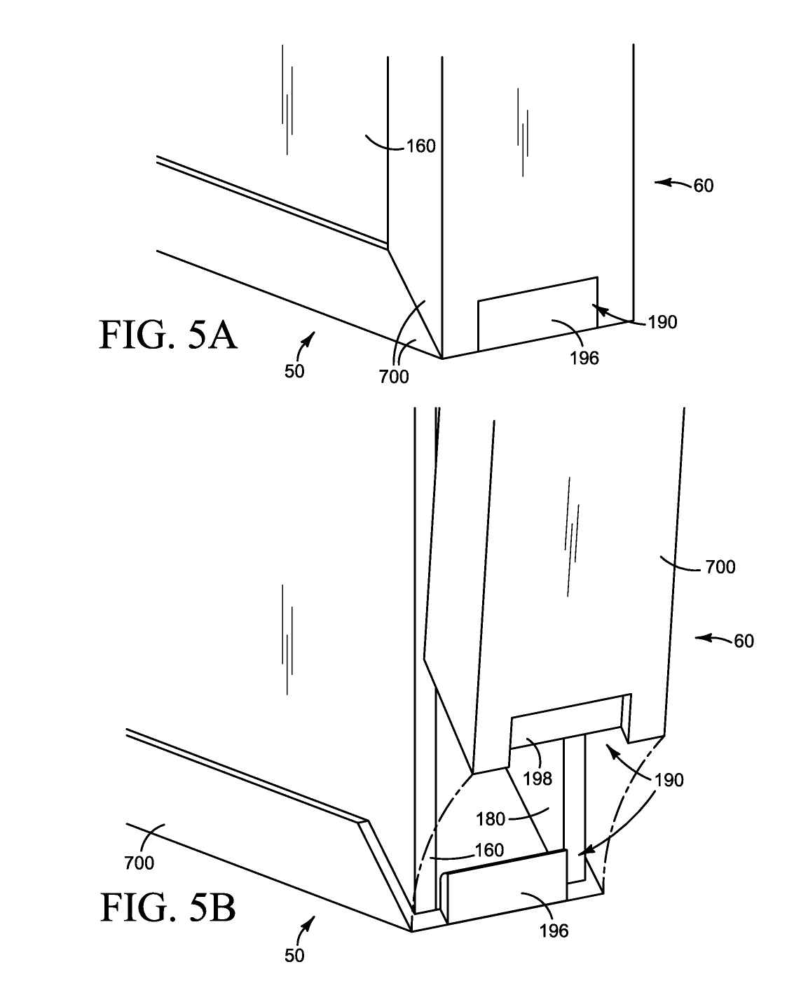

FIGS. 5A-5B show one embodiment of the retainer system 190 at the lower end of the versatile door. In FIG. 5A the latch side 60 is retained against the door body 50 by a foot 196 and a receiver which is hidden from view. The shaped channels 700 together with the door body 50 and latch side 60 capture the panel 160. FIG. 5B shows the latch side 60 removed from the door body 50. The receiver 198, previously hidden in FIG. 5A is now visible. In this embodiment, the receiver 198 is a indent in the shaped channel 700 on the latch side 60 and is configured to receive the foot 196 and hold the latch side 60 against the door body 50 when the hasp 192 and hasp catch 194 of FIGS. 4A-4C are engaged. When the latch side 60 is removed from the door body 50, the edges of panels 160 and 180 are exposed allowing their removal by sliding out of the door body 50.

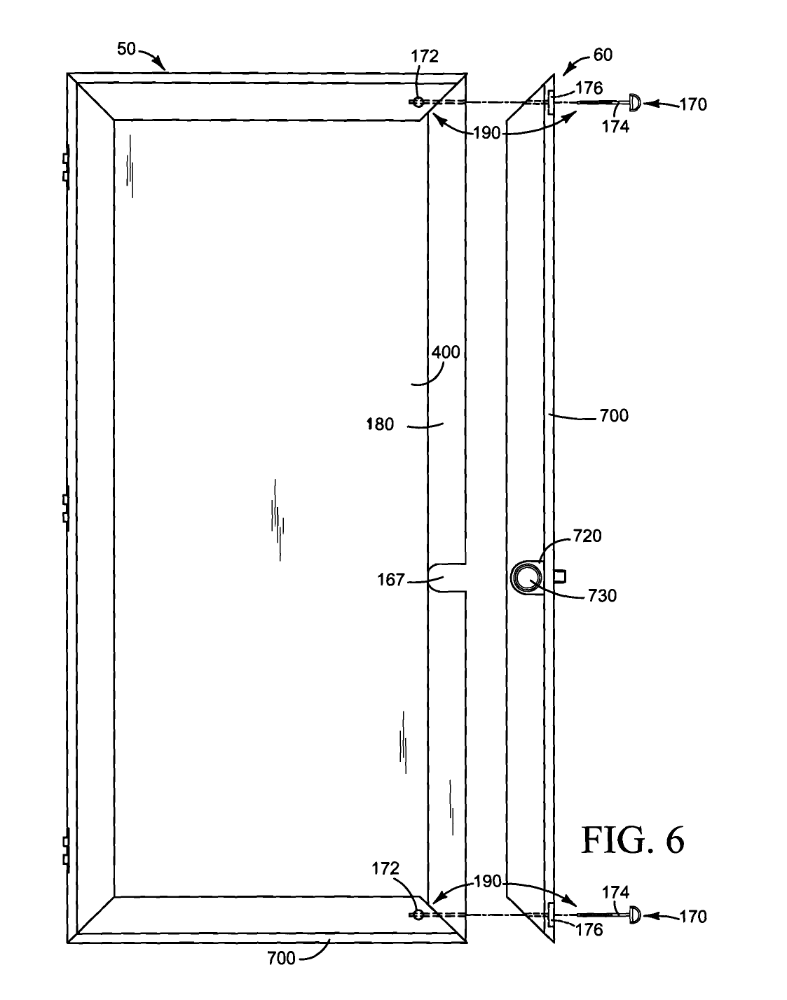

FIG. 6 shows another embodiment of the retainer system 190. This retainer system is a screw and thread system 170 in which a screw 174 passes through a hole in the latch side 60 and engages a threaded barrel 172 in the door body 50. A recess 176 for the screw 174 allows the screw 174 to fit in the latch side 60 without protruding. In this embodiment the screw 174 has a folding finger grip so that a user can loosen or tighten the screw 174 without the aid of tools. The grip folds down into the recess 176 when not in use. When the screws 174 are loosened from the threaded barrels 172 the latch side 60 is removable exposing the panels of which panel 180 is shown here. Panel 180 has a recess 167 for the latch spacer 720. In this embodiment reinforcement 400 is part of the door body 50 and provides strength and rigidity to door body 50. The screw and thread system 170 is just one embodiment of several possible embodiments available to hold the latch side 60 to the door body 50.

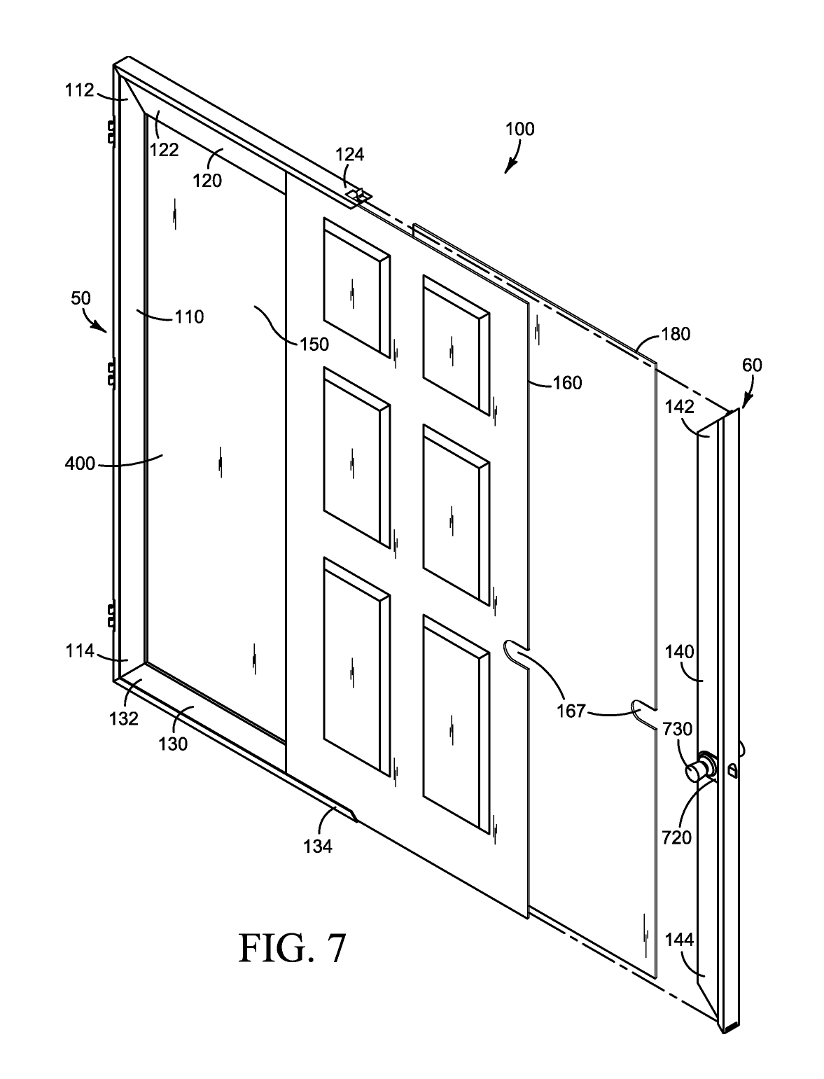

FIG. 7 shows another embodiment of the versatile door. In this embodiment door body 50 together with the latch side 60 form a door perimeter 100. The door perimeter 100 has a hinge side stile 110 with a top end 112 and a bottom end 114. A top rail 120 has a hinge end 122 and a latch end 124, the hinge end 122 attaches to the top end 112 of the hinge side stile 110. A bottom rail 130 has a hinge end 132 and a latch end 134, the hinge end 132 attaches to the bottom end 114 of the hinge side stile 110. A latch side stile 140 has a top end 142 and a bottom end 144. The bottom end 144 removeably attaches to the latch end 134 of the bottom rail 130, while the top end 142 removeably attaches to the latch end 124 of the top rail 120. Together the stiles 110, 140 and rails 120, 130 define the inner area 150 capable of capturing a panel 160 or 180. The latch side stile 140 of FIG. 7 can be attached to the upper and lower rails 120, 130 by any number of retainer systems including those described in FIGS. 4, 5, and 6.

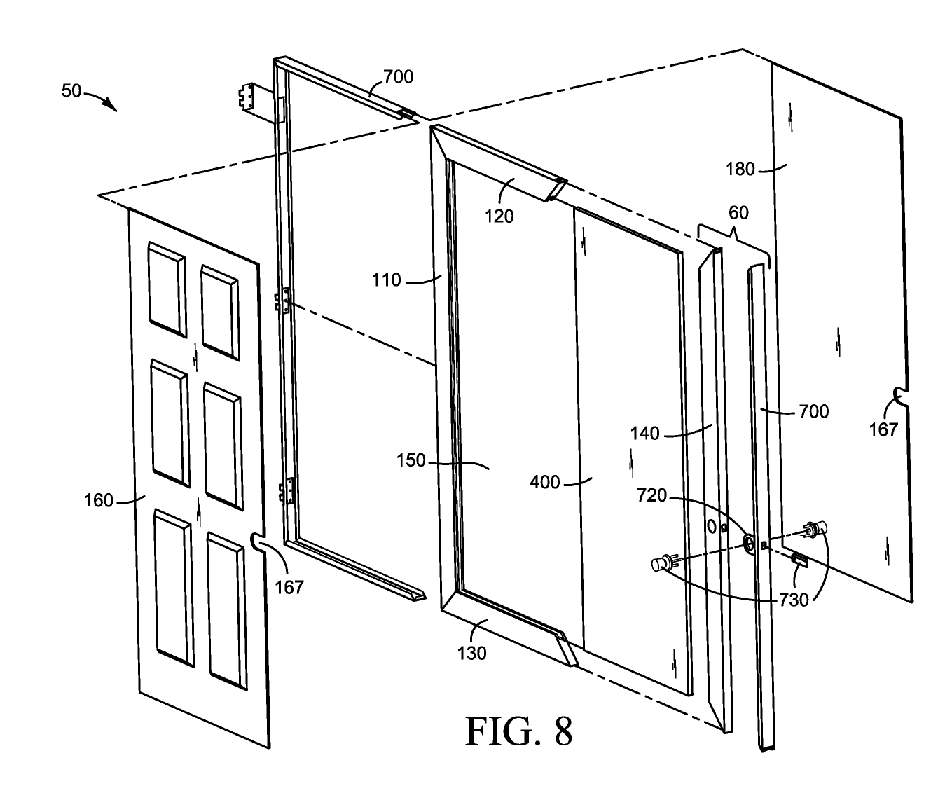

FIG. 8 shows a partially exploded view of one embodiment of the versatile door. The door body 50 is made of the stiles 110, rails 120, 130, shaped channel 700, and a reinforcement 400. The latch side is made of stile 140, shaped channel 700, latch spacer 720 and latch components 730. When the latch side 60 is attached to the door body 50, an inner space 150 is defined on either face of the reinforcement 400 for panels 160 and 180.

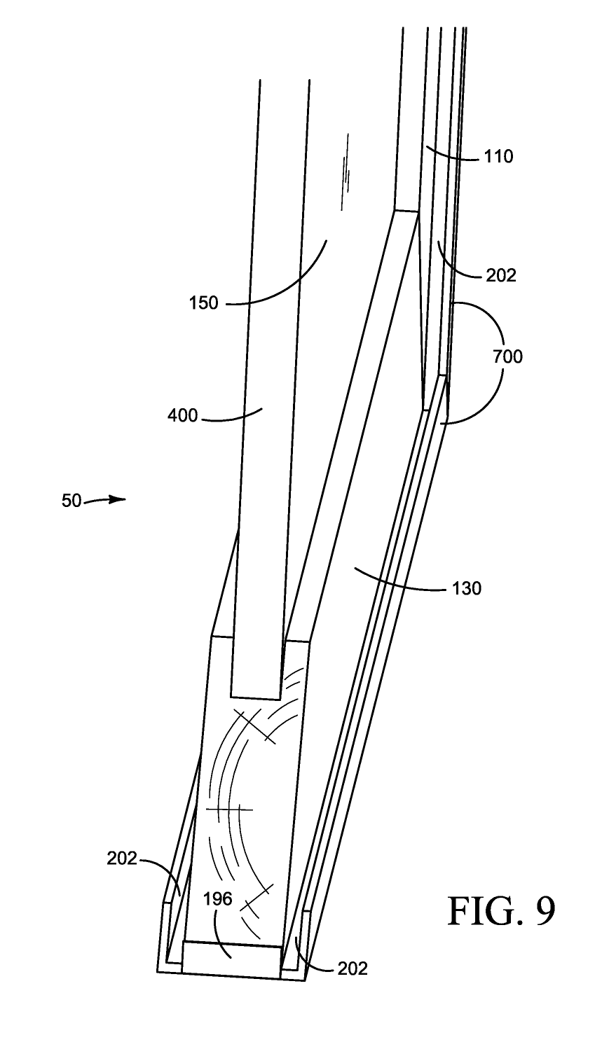

FIG. 9 shows the channel or slots in the embodiment of the versatile door shown in FIG. 8. This view is looking into the door body 50 with the latch side removed. The bottom rail 130 joins with the hinge side stile 110 and reinforcement 400 to form a major part of the door body 50. The shaped channel 700 together with the bottom rail 130 and hinge side stile 110 form grooves or slots 202 into which panels 160, 180 of FIG. 8 can slide. When the latch side 60 of FIG. 8 is attached to the door body 50, the panels 160 and 180 are captured. The inner space or area 150 described earlier in conjunction with FIGS. 7 and 8 has a perimeter bounded by the edges of the slots 202 and extends across the surface of the door body 50. In those embodiments which can accommodate two panels, there are actually two inner areas 150, one for each panel on either side of the door body 50. While the figures in this disclosure show the door body 50 and latch side 60 made of many components, other embodiments may be made in alternative configurations but still capable of capturing one or more panels 160, 180. For example instead of a separate shaped channel 700, the door components 50, 60 may each be made in one injection molded piece. Alternatively, the stiles and rails may have the grooves 202 built into them eliminating the need for a separate shaped channel 700. In other cases, major portions of the door may be extruded metal, plastic, composites or other materials. The manufacturing methods are nearly limitless. The intended door use, materials and manufacturing volume can dictate the preferred door construction.

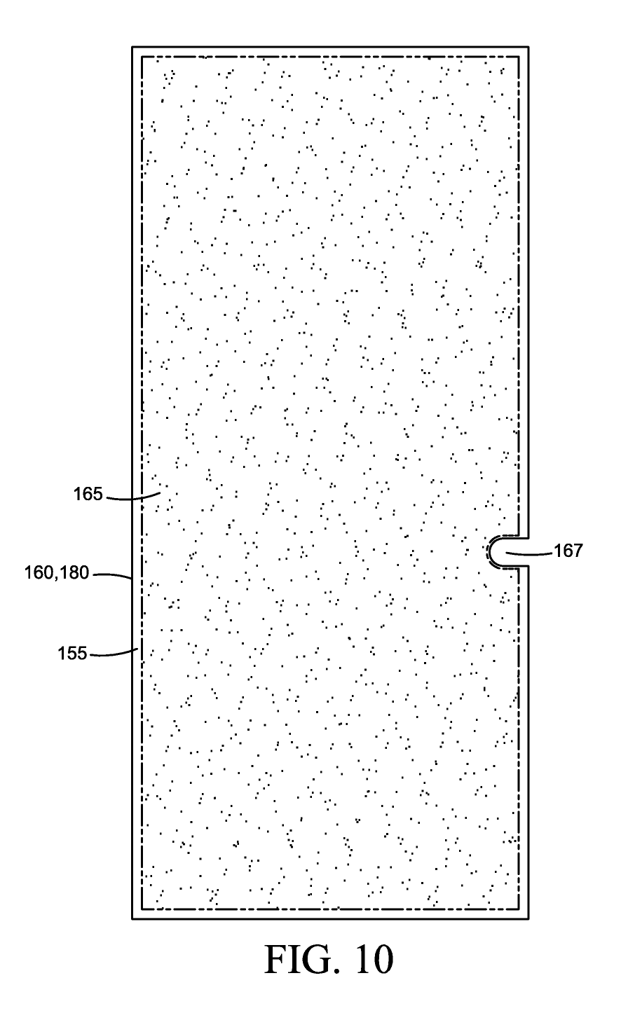

FIG. 10 shows one embodiment of a panel adapted for use in a versatile door. The panel 160, 180 has a surface 155 adapted to be captured by the door body 50 and latch side 60 described earlier. The surface 155 is sized to fit into the grooves 202 shown in FIG. 9. This surface 155 may extend into the recess area 167 if the latch spacer 720 in previous figures fits on top of the panel 160, 180. A treatment 165 is on the face of the panel 160, 180 and may extend into the surface 155 if the treatment 165 does not interfere with the fit of the panel 160, 180 in the grooves 202 of FIG. 9. The types of treatment 165 vary widely and are discussed below.

Panel treatments 165 of FIG. 10 are many and varied. In a simple form, a panel treatment 165 may be a paint, varnish, mural or other surface treatment. The panel material itself may determine the types of possible treatments. Wood panels may feature a decorative grain, inlays or venires. Plastic panels may have texture, plating or other surfaces. Metal panels may be anodized, plated or textured with sand blasting, or brushing. Other forms of panel treatment include raised or simulated stiles and rails, bas relief sculpture, fabric coverings, interlocking tiles, painting canvas or other art. Some treatments are suitable for indoor or outdoor facing panels. Other treatments are suited to mainly indoor or outdoor.

On the practical side, another type of treatment is the message medium treatment. The message medium can be a chalk board, white board, peg board cork board, poster pad, magnetic surface or similar, turning the door into a message center.

Still another treatment is the play surface. The play surface provides an attachment surface for popular children's construction toys such as Legos™, Duplos™, Tinker Toys™, and Kinex™. Children also benefit from the message medium described earlier or with other treatments such as a felt surface, glow-in-the-dark surface or shallow shelving.

A further panel treatment is illumination. The illumination can be decorative or utilitarian. For example one type of door illumination may use light emitting diodes (LEDs) for holiday lighting or color schemes. Another lighting version may use lighting to illuminate the interior of closets or rooms upon initial entry. Some lighting may be used in combination with a dressing or make-up mirror panel. The light can be adjustable to simulate various lighting environments. Embodiments where the door panel receives adequate light may employ photo voltaic panels to power the illumination source. An example might be an exterior door that lights up at night highlighting the keyhole or displays a welcome sign. Other embodiments might light up when someone knocks on the door at night.

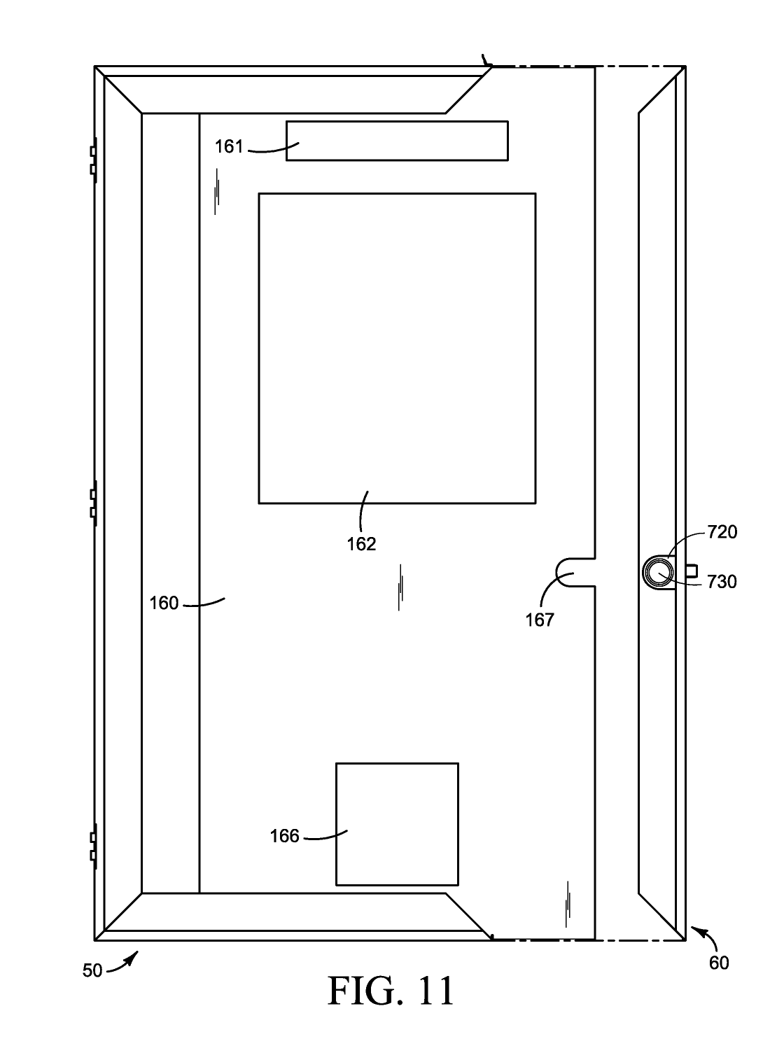

FIG. 11 shows another treatment of door panels that involves panels with openings. Depending upon the location of the panel openings they can be used for things like vents, windows, pet doors, mail or delivery slots. FIG. 11 shows three openings in one panel 160. The upper opening 161 could be used for a vent, while the central opening 162 could be used for a window. The lower opening 166 is suitable for a pet door or delivery slot. The size, number and location of openings are determined by the intended use. Versatile doors designed with openings have the reinforcement 400 of FIGS. 6, 8, and 9 with openings that correspond to the openings found in panel 160 of FIG. 11. Similarly, versatile doors with a second panel 180 as depicted in FIG. 8 have matching openings. All three items, the first panel 160, the reinforcement 400 and the second panel 180 have openings that align when the panels are installed in the versatile door. In the case that a window was no longer required, replacement panels 160 and 180 cover the opening in reinforcement 400 hiding it from view. The types of windows, vents and slots are limitless. Vents can be fixed or adjustable, screened or open, high or low on the door. Windows can be clear, frosted, stained glass openable or closed. Slots can be small such as a mail slot or large enough for delivery of milk or parcels. Other slot uses can include a flapper door for pet access. Pet access door can even include the electronic pet collar access that keeps strays and wild animals out of a residence.

In use the door panels are removed by first releasing the retainer system 190 be it the hasp and catch of FIG. 4 or loosening the screws of FIG. 6. In both of these examples tools are not required. Once the latch side 60 is removed from the door body 50 the panel 160 or the panel 180 may be removed. Removal consists of sliding the panel(s) 160, 180 out from the door body. Replacement panels are easily installed by sliding them into the door body. The latch side 60 is then re-attached to the door body 50 by the retainer system 190. Depending on the retainer system design, tools may be optional.

Door panels allow the door face to be repaired without having to remove the door itself. This can be especially useful with exterior doors or bedroom doors where security and privacy concerns limit the time that the door can be removed. With a versatile door, a temporary or replacement panel can be installed in minutes without removing the door. The sanding, preparation and paint fumes associated with some refinishing can be done separately on the panel while the door remains in service with a replacement or temporary panel. In some cases door panels may be reversible so that each door panel has two faces. When not shown, the panel face not in use is hidden, facing the inside of the door.

The various door treatments can be changed with the need. For example, in a bedroom, a door panel might include a window so parents can check on an infant without making any noise. Later a toddler might enjoy a night light in the door or a light that goes on when the door is opened for a late night bathroom trip. Preschool children can benefit from a magnetic surface panel for playing with magnetic letters and numbers. Grade school children can use a play surface with attachable toys. Adolescents may choose an illuminated mirror for make-up or dressing. After the child leaves home, the parents may repurpose the bedroom for a hobby room or home office and make use of shelves or a white board. All these uses can be accomplished with the versatile door and removable panels. Other uses for the replaceable panels are possible, especially combinations of features on one panel. For example a panel with a make-up mirror may also include make-up illumination and a storage compartment for make-up items.

Although this invention has been described in terms of certain preferred embodiments, other embodiments that are apparent to those of ordinary skill in the art, including embodiments that do not provide all of the features and advantages set forth herein, are also within the scope of this invention. Rather, the scope of the present invention is defined only by reference to the appended claims and equivalents thereof.

I claim:

1. A versatile door comprising:
a door body;
a removable latch side attached to the door body; and
a retainer system adapted to removeably attach the latch side to the door body.

2. The door of claim 1 wherein the retainer system further comprises:
a foot; and
a receiver adapted to receive the foot whereby the door body and latch side are held in alignment.

3. The door of claim 1 wherein the retainer system further comprises:
a hasp catch; and
a hasp adapted to receive the hasp catch whereby the door body and latch side are held together.

4. The door of claim 1 wherein the retainer system comprises a screw and thread system adapted to hold the latch side to the door body.

5. The door of claim 1 further comprising a latch spacer between a latch and the removable latch side.

6. The door of claim 1 wherein the door body and latch side define an inner area adapted to capture a panel.

7. The door of claim 6 wherein the inner area capable of capturing a panel is formed by a shaped channel on the door body and latch side.

8. The door of claim 6 further comprising a panel adapted to be captured in the inner area.

9. The door of claim 6 further comprising:
a second inner area capable of capturing a second panel; and
a second panel adapted to being captured within the second inner area.

10. The door of claim 1 wherein the door further comprises:
a door perimeter, the door perimeter comprising:
a hinge side stile having a top end and a bottom end;
a top rail having a hinge end and a latch end, the hinge end attached to the top end of the hinge side stile;
a bottom rail having a hinge end and a latch end, the hinge end attached to the bottom end of the hinge side stile; and
a latch side comprising a latch side stile having a top end and a bottom end, the bottom end removeably attached to the latch end of the bottom rail, the top end removeably attached to the latch end of the top rail; the stiles and rails defining an inner area capable of capturing a panel.

11. The door of claim 10 further comprising a panel adapted to be captured in the inner area defined by the stiles and rails.

12. The door of claim 11 wherein the panel is captured by grooves in the stiles and rails.

13. The door of claim 10 further comprising a reinforcement holding the hinge side stile the top rail and bottom rail in fixed relationship.

14. In a door having a door body and a removable latch side, the door body and removable latch side defining an inner area, a panel comprising:
a surface adapted to be captured within the inner area defined by the door body and latch side; and
a treatment applied to the panel.

15. In a door having a door body and a removable latch side, the door body and removable latch side defining an inner area, the removable latch side further having a latch spacer, a panel comprising:
a surface adapted to be captured within the inner area defined by the door body and removable latch side;
the panel further relieved about the latch spacer; and
a treatment applied to the panel.

16. The panel of claim 15 wherein the panel further comprises an opening.

17. The panel of claim 15 wherein the panel further comprises a message medium.

18. The panel of claim 15 wherein the panel further comprises a play surface.

19. The panel of claim 15 wherein the panel further comprises a mirror.

20. The panel of claim 15 wherein the panel further comprises illumination.
